(19) United States
(12) Patent Application Publication
(10) Pub. No.: US 2007/0165276 A1
(43) Pub. Date: Jul. 19, 2007

(54) Printing system, printing method and printing program

(75) Inventor: Teruyoshi Nakashima, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/654,591

(22) Filed: Jan. 18, 2007

(30) Foreign Application Priority Data
Jan. 19, 2006 (JP) 2006-011620

(51) Int. Cl. G06F 3/12

(52) U.S. Cl. 358/1.15

(57) ABSTRACT

A printing system comprising:

a server which receives an image and order information for identifying, a print size, the number of sheets to print the image, a destination for sending the printed image and a payment method for a print price for the printed image independently one after another from a terminal of an orderer of printing over a network;

a database for storing the image and the order information which is received by the server independently one after another in association with each other; and

a printer for printing the image according to an instruction from the server, wherein

the server stores print conditions for the printer to start printing the image, which are designated via the terminal in association with all the order information, and

the server instructs the printer to print the image based on all the order information corresponding to the print conditions, when the print conditions stored in the database are fulfilled.

### BACKGROUND OF THE INVENTION

1. Field of the Invention

The present invention relates to a printing system, a printing method and a printing program for printing an image uploaded from a customer using a network in such a manner as to meet the needs of the customer.

2. Description of the Related Art

A system that accepts a print order over a network and delivers a printed matter to a designated destination includes those shown below. According to Japanese Patent Application Laid-Open No. 2002-117102, a user who needs to print a digital image captures digital image information into a cellular phone and transmits the digital image information with order request information to a print order accepting server over a base station and a network. The order request information includes print conditions information. When the print order accepting server receives the digital image information and the print conditions information, it transmits the digital image information to be printed to a print server where printing is performed according to the print conditions. At the place where the printing is performed, an ordered print created based on the information transmitted to the print server is delivered to a transmitted destination registered for distribution.

According to Japanese Patent Application Laid-Open No. 2005-182600, a photograph transporting service providing system using a photograph data saving deposit server includes a picked-up data capturing unit, which captures picked-up data uploaded by a user operating a terminal device and registers the picked-up data with the photograph data saving deposit server, and a picked-up data providing unit, which receives a request for transmitting a picked-up data generated by a user operating the terminal device based on identifying information informed as the picked-up data is registered and outputted destination information designated by the user, reads desired picked-up data from the photograph data saving deposit server, and provides the picked-up data attached with an invoice for download.

When a user orders printing over a network, the user may order a few number of sheets for printing. Since ordering of a small number of sheets for printing comparatively costs high, the user tends to order printing after having accumulated the number of sheets for printing. As an image is printed and delivered each time images are uploaded to a server in the system according to Japanese Patent Application Laid-Open No. 2002-117102, the prints are sent out by just a small number of sheets, increasing the delivery cost. It is a matter of course that many images may be uploaded at a time, though, in such a case, a task to select such many images at a time and upload them is troublesome. Thus, the user may feel the task bothering and postpones or gives up even the printing order.

In the system according to Japanese Patent Application Laid-Open No. 2005-182600, when image data is uploaded to obtain the printing matter, designation for the printing is required again. In this system, it is doubtful whether a user can designate the images, which the user actually desires to be printed, from the large amount of data uploaded till then.

### SUMMARY OF THE INVENTION

An object of the present invention is that, even when a large amount of image data is uploaded, intending to enable a user to correctly print the desired images effectively without imposing a burden on the user.

The present invention is a printing system including a server which receives an image and order information for identifying a print size, the number of sheets to print the image, a destination for sending the printed image and a payment method for a print price for the printed image independently one after another from a terminal of an orderer of printing over a network; a database for storing the image and the order information which is received by the server independently one after another in association with each other; and a printer for printing the image according to an instruction from the server, wherein the server stores print conditions for the printer to start printing the image, which are designated via the terminal in association with all the order information, and when the print conditions stored in the database are fulfilled, the server instructs the printer to print the image based on all the order information corresponding to the print conditions.

If the print conditions are previously designated and images or order information are uploaded to the server one after another, the images are automatically printed at once based on all the order information uploaded one after another when the print conditions are fulfilled. As the user can upload images one after another, the task of collectively uploading or selecting the images the user wants to print is not required and the user can correctly obtain desired printed matters without failing in selecting the images the user actually wants to print. The delivery cost also is reduced as the images are collectively printed.

The server inquires the terminal about whether or not to change the print conditions, when the print conditions are fulfilled, and may store print conditions after change in the database as new print conditions if the terminal informs that the print conditions are to be changed, and the print conditions after the change as a result of the inquiry.

If the print conditions are fulfilled but the number of sheets to be printed will increase, the printing should not be immediately started. Therefore, if the print conditions are fulfilled, the user is given a time period for changing the print conditions again at that moment and postponing the time for starting to print.

The print conditions includes whether the total number of sheets to print which is identified by all the order information reaches a predetermined threshold designated via the terminal or not.

The server may inquire the terminal about whether or not to start the printing if the total number of sheets to print, which is identified by all the order information, falls short of the predetermined threshold and the terminal has not accessed for a predetermined period of time, and may instruct the printer to print the image based on all the order information corresponding to the print conditions, if the terminal informs the server to start printing in response to the inquiry.

If the total number of sheets to print falls short of a threshold set by the user, the printing does not start. In this case, however, if no access has been made for a predetermined period of time, it is conceivable that the user forgets ordering the printing or that the user remembers ordering the printing but misunderstands that the prints are failed to be delivered. Consequently, the user is called attention by an inquiry about starting the printing even if the print conditions are not fulfilled.

The print conditions include whether the current date and time reaches a designated date and time inputted from the terminal or not.

The server may inquire the terminal about whether or not to change the designated date and time to a date and time after the current date and time, if the current date and time reaches the designated date and time inputted from the terminal, and may store a designated date and time after change in the database as a new designated date and time, if the terminal informs that the designated time and date is to be changed, and the designated time and date after the change in response to the inquiry.

It is meaningless to store the designated date and time as print conditions after the current date and time has already reached the designated date and time. Therefore, the user is prompted to change the designated date and time for a new designated date and time.

If the server does not receive the order information, the server may store predetermined order information including at least a predetermined print size or a predetermined number of sheets to print in the database.

Basically, as neither the print size nor the number of sheets to print changes in each order, the predetermined order information is stored unless otherwise no designation is done. In this manner, the user does not need to upload the same order information one after another.

The present invention is a printing method used in a printing system including a server which receives an image and order information for identifying, a print size, and the number of sheets to print the image, a destination for sending the printed image and a payment method for a print price for the printed image independently one after another from a terminal of an orderer of printing over a network; a database for storing the image and the order information which is received by the server independently one after another in association with each other; and a printer for printing the image according to an instruction from the server, including the steps of: storing in the database print conditions for the printer to start printing the image, which are designated via the terminal in association with all the order information; and instructing the printer to print the image based on all the order information corresponding to the print conditions when the print conditions stored in the database are fulfilled.

The present invention is also a printing program used in a printing system including a server which receives an image and order information for identifying, a print size, the number of sheets to print the image, a destination for sending the printed image and a payment method for a print price for the printed image independently one after another from a terminal of an orderer of printing over a network; a database for storing the image and the order information which is received by the server independently one after another in association with each other; and a printer for printing the image according to an instruction from the server, wherein the printing program causes the printing system to execute the steps of: storing in the database print conditions for the printer to start printing the image, which are designated via the terminal in association with all the order information; and instructing the printer to print the image based on all the order information corresponding to the print conditions when the print conditions stored in the database are fulfilled.

In the present invention, if the print conditions are previously designated and images or order information are uploaded to the server one after another, the images are printed automatically at once based on all the order information uploaded one after another when the print conditions are fulfilled. As a user can upload images one after another, the user can omit a task of collectively uploading and selecting images, which the user wants to print, and can correctly obtain desired printed matters without failing in selecting the images the user actually wants to print. The delivery cost also is reduced as the images are collectively printed.

### BRIEF DESCRIPTION OF THE DRAWINGS

FIG. 1 is a configuration diagram of a print ordering system;

FIG. 2 is a flowchart showing a flow of a print conditions registering operation;

FIG. 3 is a flowchart showing a flow of a printing operation according to a first embodiment; and

FIG. 4 is a flowchart showing a flow of a printing operation according to a second embodiment.

### DETAILED DESCRIPTION OF THE PREFERRED EMBODIMENTS

Preferred embodiments of the present invention will be described below with reference to the attached drawings.

### First Embodiment

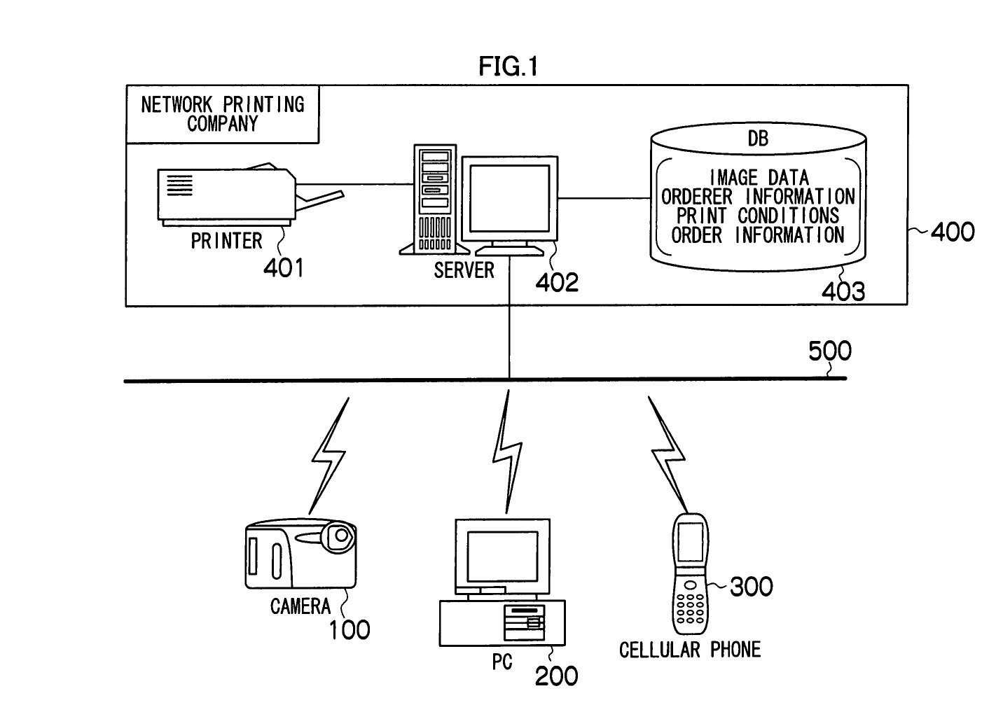

FIG. 1 is a diagram showing an embodiment of a printing system according to the present invention. The printing system includes a digital camera 100 provided with a network connecting function such as a wireless LAN function or the like, a personal computer 200, a print ordering terminal such as a cellular phone 300, and a communication network 500 for connecting the print ordering terminal and a network printing company 400.

The network printing company 400 includes a printer 401, a server 402 and a database 403.

The cellular phone 300 includes a function of a digital still camera for recording image data representing an object image in addition to a communication function. In the cellular phone 300, first, an orderer inputs information indicating an image, which is an object of a printing order. If it is the first time for the image to be ordered for printing, image data representing the image is inputted. If the image was ordered for printing, identifying information for identifying the image data representing the image saved in the database 403 is inputted. The identifying information has saved place information indicating the database 403, in which the image data representing the image to be printed is saved, and a file name of the image data. The image data may be obtained by using an image pick-up apparatus such as the digital still camera 100 in addition to the cellular phone 300, stored in the personal computer 200 in a predetermine manner, and transmitted from the personal computer 200 to the network printing company 400. If the images can be directly transmitted from the digital still camera 100 to the server 402, the personal computer 200 is not needed.

The image data to be printed may be saved in the database 403 for a certain period of time, and the server 403 is accessed from the print ordering terminal such as the cellular phone 30 so that the image data is arbitrarily downloaded from the database 403 during the saving period of time. In such a manner, the images need not be saved in the cellular phone 300 or the like so that the limited storage for images can be effectively utilized. When the saving period of time for an image elapsed or when an image is designated to be deleted from the cellular phone 300 or the like, the image is immediately deleted from the database 403, or deleted after informing the cellular phone 300 or the like with giving a time for creating a necessary backup. Alternatively, image data is continuously saved in the database 403 without limiting a period of time and the saving price for the image data is charged to a user according to the saving period of time.

Further, from the print ordering terminal such as the cellular phone 300, order information indicating information relating to ordering such as the size and the number of sheets for printing, and desired image processing, orderer information (name, street address, phone number and the like) for identifying the orderer, and miscellaneous information such as print conditions to be described later are inputted.

The size and the number of sheets for printing are a predetermined size and the predetermined number of sheets for printing designated by the server 402 unless otherwise they are designated by the order information. This is because that the size and the number of sheets to print basically do not change (for example, the size is the large size and the number of sheets is one for each image) and it is troublesome for a user to designate the same value every time.

Such miscellaneous information is converted into signals to be print request data and transmitted from the cellular phone 300 or the like to the network printing company 400 over the network 500.

The print request data received by the network printing company 400 includes any one or all or a part of the image data representing an image to be an object of the printing order, identifying information, order information or orderer information, which are stored in corresponding regions in the database 403, respectively.

The network printing company 400 saves image data in the database 403 since it received the image data until a predetermined period of time for saving image data is expired (for example, one month). The image data may be transmitted and received as contained in the print request data or may be transmitted and received separately from the print request data. The image data is at least independent of the order information. As pieces of the image data are transmitted from the cellular phone 300 to the server 402 in the preferential order, the orderer information and the image data are stored in the database 403 in association with each other. That is, the user can upload the image data, which the user wants to print, to the database 403 one after another, without being required to select image data in uploading and the user needs not to worry about failing in storing the necessary image data. The user can designate the image that the user wants to print by transmitting its identifying information, and also sort out later the image the user wants to print. The user needs not to print all the images stored in the database 403.

The server 402 repeatedly determines whether the print conditions stored in the database 403 are fulfilled or not. If it determines that the print conditions are fulfilled, it extracts the image data from the database 403 according to the order information and performs image processing indicated by the order information included in the print request data. Then, the server 402 transmits the processed image data to the printer 401 and instructs to print the image in the number of sheets according to the order information. The printed matter outputted from the printer 401 is delivered according to the orderer information. If the order information is divided into small portions and transmitted one after another, the printing can be performed when the print conditions are fulfilled. Thus, even if a large amount of image data is stored in the database 403, no troublesome operation is required for transmitting the order information for printing the image data in multiple sheets all at once.

The print ordering function of the cellular phone 300 described above also has other print ordering terminals such as the digital camera 100, and the personal computer 200.

A flow of an operation of the system will be described.

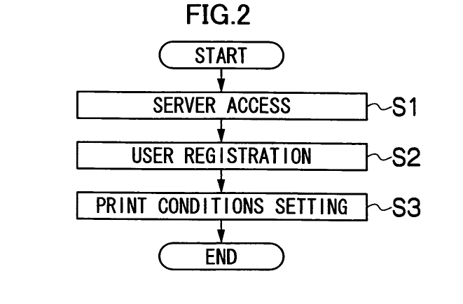

FIG. 2 is a flowchart showing a flow of a print conditions registering operation.

First, a user accesses the network printing company 400 by using the print ordering terminal such as the cellular phone 300 (S1).

The user transmits the orderer information including the user's name and password via the print ordering terminal to the network printing company 400. The network printing company 400 registers the received orderer information with the database 403 (S2).

The user sets print conditions via the print ordering terminal such as the cellular phone 300 (S3). The print conditions are for the server 402 to instruct the printer 401 to start printing the image data. At this step, a setting for changing the print conditions can be registered again when the print conditions are fulfilled. This is because that even if the print conditions are fulfilled, the user may not want to immediately start printing at that moment. For example, in the case where the print conditions are fulfilled as the images are uploaded to the server 402 one after another while a user is in a travel, the user can increase a threshold of the number of sheets for printing of the print conditions so as not to start the printing until the travel ends if the terminal is adapted to inquire the user whether or not to change the threshold.

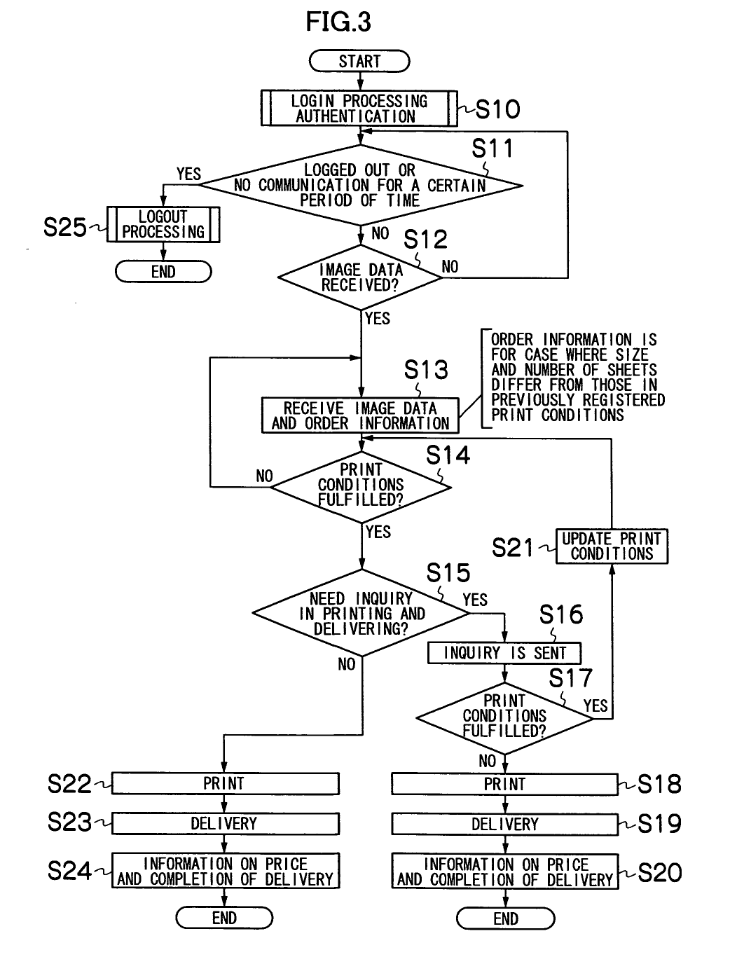

FIG. 3 is a flowchart showing a flow of a printing operation.

First, the server 402 compares the orderer information which is previously registered with the database 403 and access request information (user name, password, barcode information) transmitted from the print ordering terminal such as the cellular phone 300 and authenticates the access request from the print ordering terminal such as the cellular phone 300 (hereinafter, represented by the cellular phone 300) (S10).

The server 402 determines whether the cellular phone 300 requested to log out (disconnect the access) or a certain period of time expired without communication data being transmitted (S11).

The server 402 asks the user of the cellular phone 300, which was authenticated for the access, in a form of a message or the like, whether or not to transmit image data, which the user wants to order for printing, to the server 402. The user transmits the image data via the cellular phone 300. The server 402 determines whether it received the image data, which has been transmitted from the cellular phone 300 (S12).

If it is determined that the image data is received at the step S12, the user of the cellular phone 300 transmits the order information including information on the designated size and number of sheets to print the image data among the transmitted images, information on a destination of sending the printed matter, and information on a payment method of a print price. The order information needs not be transmitted together with the image data. If the size and the number of sheets to print are not designated by the order information, a predetermined size and the predetermined number of sheets are automatically set at the server 402. The server 402 stores the order information received from the cellular phone 300 and the orderer information used for authenticating the access in association with each other in the database 403 (S13).

The server 402 references all the order information stored in the database 403 and determines whether the print conditions registered at S3 of the print conditions registering operation are fulfilled or not (S14). If no print conditions are registered, it is determined that the print conditions are fulfilled. In such a manner, a demand for immediately printing the image can be met.

Even if the print conditions are fulfilled, the server 402 determines whether a setting for enabling the print conditions to be changed is registered at that moment or not (S15). The setting can be registered together with the print conditions at the S3 of the print conditions registering operation.

If it is determined that the setting is registered at S15, the server 402 inquires the user about whether the print conditions are to be changed or not via the cellular phone 300 (S16). The user informs the decision on whether or not to change the print conditions to the server 402 via the cellular phone 300.

The inquiry on changing the print conditions needs not to be limited to the case where it is determined that the setting is registered at S15. For example, the inquiry may be made on the basis of needs to prompt the user to change the print conditions without regard of the user's setting, such as to make the inquiry when the date registered as the print conditions passes the current date.

The server 402 determines whether or not the cellular phone 300 has informed that the print conditions are to be changed, and print conditions after the change (S17).

If it is determined that no information to change the print conditions is not given at S17, the server 402 instructs the printer 401 to print the image according to the order information (S18). The server 402 prints out or displays the name and the street address of the orderer information on the display so that a printed matter obtained by printing is sent to the place for receiving the printed matter designated by the user (S19). A staff at the network printing company 400 references the necessary information outputted by the server 402 for sending and prepares to send the printed matter to the designated place.

The server 402 informs the cellular phone 300 the print price and that the printed matter has been sent out (S20). The user who received the sent out printed matter pays the print price by cash on delivery or various kinds of future payment such as payment at the convenience store. The payment for the print price preferably is a future payment. If the inquiry is made on changing the print conditions in printing or before the printed matter is sent out, the advanced payment such as credit card payment or bank transfer may be adopted, but arises such a disadvantage that the payment needs to be added by the time of instructing to print or sending out the printed matter.

If it is determined that information to change the print conditions is given at S17, the server 402 accepts the change in the print conditions from the cellular phone 300 (S21). The changed print conditions are registered with the database 403. Then, it is determined again whether the changed print conditions are fulfilled or not at S14.

If it is determined that the setting is not registered at SI 5, the server 402 instructs the printer 401 to print according to the order information (S22). The printed matter obtained by printing is sent out to the place for receiving the printed matter designated by the user (S23).

The server 402 informs the cellular phone 300 the print price and that the printed mater has been sent out (S24). The user who received the sent out printed matter pays the print price by cash on delivery or various kinds of future payment such as payment at the convenience store.

If it is determined that logout is requested or no communication is made for a certain period of time at S11, the server 402 logs out for terminating connection with the cellular phone 300 (S25).

An example of the print conditions, which can be registered by a user in the print conditions registering operation and an operation of executing the printing operation according to the print conditions are shown below.
Whether the total number of sheets for printing order or the total number of pieces of image data designated by the same user in the order information reached a threshold arbitrarily designated by a user or a predetermined threshold previously defined by the network printing company 400. For example, if the user registered “50” for the threshold, the image is printed and sent out when the number of sheets for printing order or the total number of pieces of the image data reaches 50. It is effective to send a certain number of sheets at once instead of dividing the number of sheets to be sent out at a time into small portions to reduce the delivery cost.
Whether the current date reaches the date for issuing a printing instruction, which is arbitrarily designated by a user or previously determined by the network printing company 400. For example, if the user registers “September 30^{th}, 2005” as the date for issuing the printing instruction, the printing starts on Sep. 30, 2005 and the printed matter is sent out. It is effective in reducing the delivery cost by collectively sending the printed matters at a certain time instead of sending them at different times.
Whether the current date reaches time for issuing a printing instruction which is previously determined by the network printing company 400 or not (start of the month, end of the month, early part of the month, middle part of the month, latter part of the month, end of the year, start of the year or the like). It is effective in avoiding printing instructions according to orders from different users intensively being issued at the same period of time. If the print price is discounted for a user who registered the off-peak period of time as the print conditions, the period of time for printing may be lead to be dispersed into various periods of time.
Whether the destinations for sending the printed matter designated by the same user in different pieces of order information are the same or not. It is effective in reducing the delivery cost by sending the printed matters to be sent along the same delivery route at once.
Whether the sizes of the printed matter designated by the same user in different pieces of order information are the same or not. It is effective in reducing the delivery cost by sending the printed matters of the same size at once that can be delivered in the same package.
Whether the payment method of the price of the printing order that is arbitrarily designated by a user in the order information (cash on delivery, payment at the convenience store, credit card payment, bank transfer, payment over a network and the like) corresponds to the payment method previously determined by the network printing company 400. Alternatively, whether the same user designated the same payment method or not. It is effective for the network printing company 400 in reducing the payment cost.
Whether the number of sheets of the printed maters of an image designated by a piece of order information reaches a threshold arbitrary designated by a user or previously determined by the network printing company 400 or not. It is effective in reducing the cost by printing the same image for one order at once.

Any conditions may be used as long as they relate to the network printing instead of being limited to the above mentioned conditions. Those skilled in the art can arbitrarily change the conditions according to the embodiment.

### Second Embodiment

If it is determined that the total number of sheets for order does not reach the registered number of sheets at S14 of the print processing of the first embodiment, the printing is not executed even if the time is elapsed. Since no printed matter is delivered as time passes, it is conceivable that the user may lose reliability in the system or forget ordering to print the image.

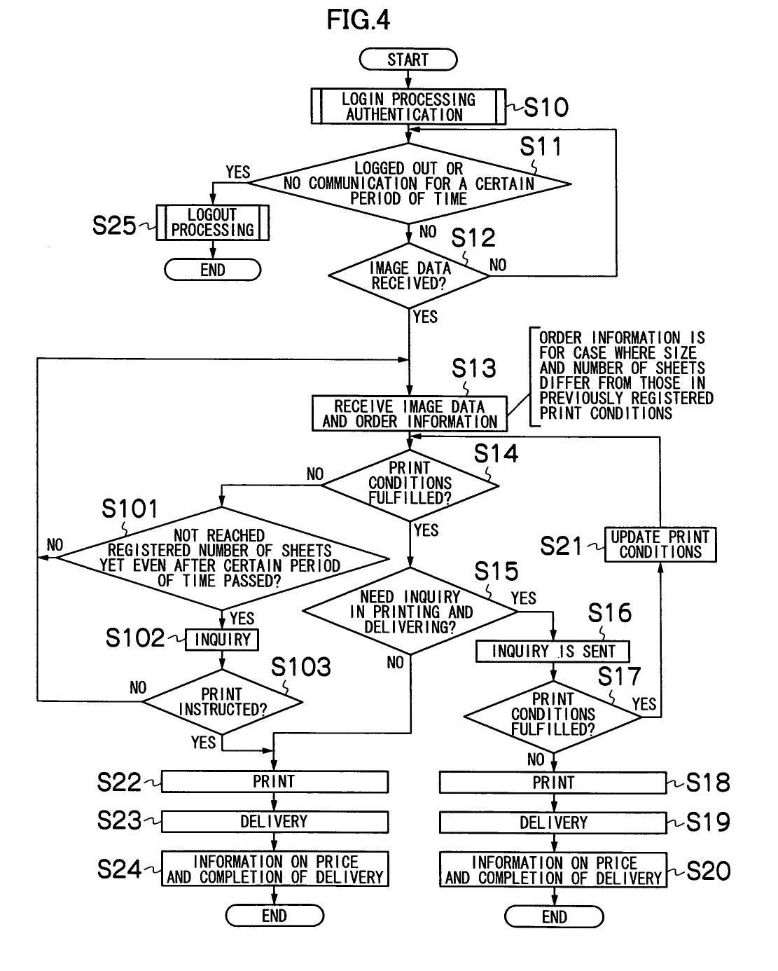

As such, if the server 402 determines that the total number of sheets for the order does not reach the registered number of sheets when a certain period of time passed from the latest logon occasion as shown in FIG. 4 (for example three month) (“Y” at S101), the server 402 inquires the print ordering terminal of the user about whether or not to start printing without condition (S102). If an instruction to start printing without condition is given from the print ordering terminal (“Y” at S103), the processing transfers to S22, where the server 402 instructs the printer 401 to print based on the order information already stored in the database 403 even if the print conditions are not fulfilled.

In such a manner, an image, which falls short of the print conditions, is not left as it is.

What is claimed is:

1. A printing system comprising:
a server which receives an image and order information for identifying, a print size, the number of sheets to print the image, a destination for sending the printed image and a payment method for a print price for the printed image independently one after another from a terminal of an orderer of printing over a network;
a database for storing the image and the order information which is received by the server independently one after another in association with each other; and
a printer for printing the image according to an instruction from the server, wherein
the server stores print conditions for the printer to start printing the image, which are designated via the terminal in association with all the order information, and
the server instructs the printer to print the image based on all the order information corresponding to the print conditions, when the print conditions stored in the database are fulfilled.

2. The printing system according to claim 1, wherein the server inquires the terminal about whether or not to change the print conditions when the print conditions are fulfilled, and stores print conditions after change in the database as new print conditions if the terminal informs that the print conditions are to be changed, and the print conditions after the change as a result of the inquiry.

3. The printing system according to claim 1, wherein the print conditions include whether the total number of sheets to print which is identified by all the order information reaches a predetermined threshold designated via the terminal or not.

4. The printing system according to claim 2, wherein the print conditions include whether the total number of sheets to print which is identified by all the order information reaches a predetermined threshold designated via the terminal or not.

5. The printing system according to claim 3, wherein the server inquires the terminal about whether or not to start the printing if the total number of sheets to print, which is identified by all the order information, falls short of the predetermined threshold and the terminal has not accessed for a predetermined period of time, and instructs the printer to print the image based on all the order information corresponding to the print conditions, if the terminal informs the server to start the printing in response to the inquiry.

6. The printing system according to claim 4, wherein the server inquires the terminal about whether or not to start the printing if the total number of sheets to print, which is identified by all the order information, falls short of the predetermined threshold and the terminal has not accessed for a predetermined period of time, and instructs the printer to print the image based on all the order information corresponding to the print conditions, if the terminal informs the server to start the printing in response to the inquiry.

7. The printing system according to claim 1, wherein the print conditions include whether the current date and time reaches a designated date and time inputted from the terminal or not.

8. The printing system according to claim 2, wherein the print conditions include whether the current date and time reaches a designated date and time inputted from the terminal or not.

9. The printing system according to claim 7, wherein the server inquires the terminal about whether or not to change the designated date and time to a date and time after the current date and time, if the current date and time reaches the designated date and time inputted from the terminal, and stores a designated date and time after change in the database as a new designated date and time, if the terminal informs that the designated time and date is to be changed, and the designated time and date after the change in response to the inquiry.

10. The printing system according to claim 8, wherein the server inquires the terminal about whether or not to change the designated date and time to a date and time after the current date and time, if the current date and time reaches the designated date and time inputted from the terminal, and stores a designated date and time after change in the database as a new designated date and time, if the terminal informs that the designated time and date is to be changed, and the designated time and date after the change in response to the inquiry.

11. The printing system according to claim 1, wherein the server stores defined order information including at least a predetermined print size or a predetermined number of sheets to print in the database, if the server does not receive the order information.

12. The printing system according to claim 2, wherein the server stores defined order information including at least a predetermined print size or a predetermined number of sheets to print in the database, if the server does not receive the order information.

13. The printing system according to claim 3, wherein the server stores defined order information including at least a predetermined print size or a predetermined number of sheets to print in the database, if the server does not receive the order information.

14. The printing system according to claim 4, wherein the server stores defined order information including at least a predetermined print size or a predetermined number of sheets to print in the database, if the server does not receive the order information.

15. The printing system according to claim 5, wherein the server stores defined order information including at least a predetermined print size or a predetermined number of sheets to print in the database, if the server does not receive the order information.

16. The printing system according to claim 6, wherein the server stores defined order information including at least a predetermined print size or a predetermined number of sheets to print in the database, if the server does not receive the order information.

17. The printing system according to claim 7, wherein the server stores defined order information including at least a predetermined print size or a predetermined number of sheets to print in the database, if the server does not receive the order information.

18. The printing system according to claim 8, wherein the server stores defined order information including at least a predetermined print size or a predetermined number of sheets to print in the database, if the server does not receive the order information.

19. The printing system according to claim 9, wherein the server stores defined order information including at least a predetermined print size or a predetermined number of sheets to print in the database, if the server does not receive the order information.

20. The printing system according to claim 10, wherein the server stores defined order information including at least a predetermined print size or a predetermined number of sheets to print in the database, if the server does not receive the order information.

21. A printing method used in a printing system comprising:
a server which receives an image and order information for identifying a print size, the number of sheets to print the image, a destination for sending the printed image and a payment method for a print price for the printed image independently one after another from a terminal of an orderer of printing over a network;
a database for storing the image and the order information which is received by the server independently one after another in association with each other; and
a printer for printing the image according to an instruction from the server, comprising the steps of:
storing in the database print conditions for the printer to start printing the image, which are designated via the terminal in association with all the order information; and
instructing the printer to print the image based on all the order information corresponding to the print conditions when the print conditions stored in the database are fulfilled.

22. A printing program used in a printing system comprising:
a server which receives an image and order information for identifying a print size, the number of sheets to print the image, a destination for sending the printed image and a payment method for a print price for the printed image independently one after another from a terminal of an orderer of printing over a network;
a database for storing the image and the order information which is received by the server independently one after another in association with each other; and
a printer for printing the image according to an instruction from the server, wherein the printing program causes the printing system to execute the steps of:
storing in the database print conditions for the printer to start printing the image, which are designated via the terminal in association with all the order information; and
instructing the printer to print the image based on all the order information corresponding to the print conditions when the print conditions stored in the database are fulfilled.
